(19) United States
(12) Patent Application Publication
(10) Pub. No.: US 2016/0334032 A1
(43) Pub. Date: Nov. 17, 2016

(54) HOSE-SHAPING APPARATUS

(71) Applicants: Randy C. Foster, Strafford, MO (US); James Wakeem, Springfield, MO (US)

(72) Inventors: Randy C. Foster, Strafford, MO (US); James Wakeem, Springfield, MO (US)

(73) Assignee: DAYCO IP HOLDINGS, LLC, Springfield, MO (US)

(21) Appl. No.: 14/711,313

(22) Filed: May 13, 2015

(51) Int. Cl. F16L 3/015; F16L 3/26

(52) U.S. Cl. CPC F16L 3/015; F16L 3/26

(57) ABSTRACT

A hose-shaping apparatus is disclosed that includes a plurality of ribs spaced apart from each neighboring rib along a flexible spine. Each of the ribs define a first opening for receiving a section of hose and two or more ribs define second openings for receiving a shaping member. The shaping member is inserted through the second openings and tightened to form the hose-shaping apparatus into an assembled state to affect a bend in the section of hose. Unassembled, the spine defines a preselected distance between the ribs, and in the assembled state, the ribs, at a position generally opposite the spine, are spaced apart a distance less than the preselected distance. A method for shaping a hose using the hose-shaping apparatus is also disclosed. The hose-shaping apparatus may be used to reproduce custom-shaped hoses for aftermarket replacement of vehicle engine hoses.

### TECHNICAL FIELD

The present invention relates to hoses, in particular to apparatuses and methods for bending hoses into custom shapes.

### BACKGROUND

Engines, and specifically vehicle engines, include a number of custom-shaped hoses for transporting coolants, lubricants, air, or other fluids from place to place within the engine. These custom-shaped hoses often have multiple bends of varying degrees and in varying bend planes in order for the hose to weave through and around the complex array of components in a modern vehicle engine. For example, a typical vehicle engine often includes multiple small diameter engine coolant hoses, each with multiple bends, that are predominantly found on the heater hose circuits. Some vehicle engines can have four or more of these custom-shaped hoses. The number and shape of these hoses can vary greatly from manufacturer to manufacturer and from engine model to engine model.

Original equipment manufacturers (OEM) produce these custom-shaped hoses for new vehicles and for service for at least a few years after release of a particular vehicle engine. However, after the OEM ceases making the custom-shaped hoses for the particular vehicle engine, a vehicle owner is often unable to find suitable replacements for the custom-shaped hoses in the aftermarket, which may lead the vehicle owner to block off a specific fluid circuit, such as the heating circuit, or coming up with an inappropriate and poorly fitting substitution. Developing and tooling custom-shaped hoses to match the OEM specification is expensive, and aftermarket retailers encounter cost and space limitations in attempting to stock a wide array of custom-shaped hoses to accommodate the wide variety of vehicle engine manufacturers and models. It is desirable to have a cost-effective apparatus to form hoses into custom shapes for aftermarket replacement of custom-shaped hoses in vehicle engines.

### SUMMARY

According to one aspect of the present disclosure, a hose-shaping apparatus is disclosed that includes a plurality of ribs, each spaced apart from each neighboring rib along a flexible spine and each rib defining a first opening for receiving a section of hose and two or more ribs further defining a second opening for receiving a shaping member that secures the plurality of ribs in an assembled state to affect a bend in the section of hose. The flexible spine, in an unassembled state, defines a preselected distance between the plurality of ribs. In the assembled state, the plurality of ribs, at a position generally opposite the spine, are spaced apart a distance less than the preselected distance.

In another aspect of the previous embodiments of the hose-shaping apparatus, the plurality of ribs is generally cylindrically-shaped. In another aspect of the previous embodiments, the second opening is shaped to receive a wire, cable tie, string, or strap for securing the hose-shaping apparatus in an assembly position about a hose. In another aspect, the second opening is positioned generally opposite the spine.

In another aspect of the previous embodiments, the plurality of ribs further defines a third opening for receiving a leader line to pull the hose-shaping apparatus onto a hose or for receiving a secondary shaping member. In another aspect of the previous embodiments, the hose-shaping apparatus includes a shaping member received through the second openings. In another aspect, the shaping member has an engaging end that is engageable with a receiving end, and the receiving end has a locking mechanism to prevent disengagement of the engaging end from the receiving end. The shaping member may be one or more cable ties.

According to another aspect of the present disclosure, a hose assembly is disclosed that includes a hose-shaping apparatus according to any of the previous embodiments, a hose received through the first opening of each of the plurality of ribs of the hose-shaping apparatus, and a shaping member received through the second openings of the plurality of ribs that have a second opening. The shaping member is tightened to manipulate the hose-shaping apparatus and the hose into at least a first bend. In another aspect of the previous embodiments, the shaping member is a wire tie having a locking mechanism to prevent disengagement of an engaging end of the wire tie from a receiving end of the wire tie. In one embodiment, the shaping member is a cable tie.

According to another aspect, a method for shaping a hose is disclosed that includes the steps of utilizing or providing a hose-shaping apparatus according to any of the previous embodiments, feeding a hose through the first openings of the plurality of ribs, inserting a shaping member through the second openings of the plurality of ribs, and securing the shaping member in a position that reduces the length of the shaping member within the second openings, thereby drawing the portion of the plurality of ribs having the second openings closer to one another to form at least a first bend in the hose. In another aspect of the previous embodiment, securing the shaping member includes inserting an engaging end of the shaping member into a receiving end thereof and drawing a length of the shaping member through the receiving end. In another aspect, the method for shaping a hose includes cutting the hose-shaping apparatus to a desired length by cutting the spine between adjacent neighboring ribs. In another aspect of the previous embodiments, the method includes trimming an excess portion of the length of the shaping member after securing the shaping member.

According to another aspect of the previous embodiments, one or more of the plurality of ribs has a third opening, and the method further includes securing a leader to the third openings in the plurality of ribs. Feeding the hose further includes pulling the hose-shaping apparatus onto the hose using the leader.

According to another aspect of the present disclosure, a hose-shaping kit includes a plurality of individual ribs and/or a hose-shaping apparatus having a plurality of ribs spaced apart from each neighboring rib along a flexible spine, each rib defining a first opening to receive a length of a hose and two or more ribs further defining second openings. The kit also includes a shaping member to be inserted through the second openings in the ribs and to be tightened to assemble the plurality of individual ribs and/or the hose-shaping apparatus into an assembled state in which the plurality of individual ribs and/or the plurality of ribs, at a position of the second opening, are to be spaced apart a distance less than other portions of the ribs. In another aspect of the previous embodiment, each rib further defines a third opening, and the hose-shaping kit further includes a leader line to be coupled to an initial rib and inserted through the third openings of the other ones of the plurality of individual ribs and/or plurality of ribs. The leader line is to be used to pull the plurality of individual ribs and/or plurality of ribs onto the section of hose.

According to another aspect, the hose-shaping kit of previous embodiments may include a plurality of hose-shaping apparatuses of at least two different sizes. One or more of the plurality of hose-shaping apparatuses is to be selected for a specific size of hose. In another aspect of the previous embodiments, the hose-shaping kit includes a section of hose to be inserted through the first openings in the hose-shaping apparatus and shaped into a custom-shaped hose.

In another aspect of the present disclosure, a hose-shaping system is disclosed that includes a plurality of ribs defining a first opening for receiving a section of hose and defining a second opening and a shaping member insertable through the second opening in the plurality of ribs and having ends that connect together to form a loop for defining a shape of the section of hose. In another aspect of the previous embodiment, tightening the shaping member reduces the size of the loop and causes a distance between each of the plurality of ribs to decrease with increasing proximity to the second opening.

### DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A is a perspective view of a hose-shaping apparatus as disclosed herein.

FIG. 1B is a front view of the hose-shaping apparatus of FIG. 1A.

FIG. 1C is a side view of the hose-shaping apparatus of FIG. 1A.

FIG. 2A is a perspective view of another hose-shaping apparatus disclosed herein.

FIG. 2B is a front view of the hose-shaping apparatus of FIG. 2A.

FIG. 2C is a side view of the hose-shaping apparatus of FIG. 2A.

FIGS. 3A-3C are front views of alternative embodiments of hose-shaping apparatuses having various configurations of second openings and third openings.

FIG. 4 is a side view of another embodiment of a hose-shaping apparatus disclosed herein.

FIG. 5 is a perspective view illustrating an assembled hose-shaping apparatus of FIG. 1 on a length of hose.

FIG. 6 is a perspective view of a hose assembly, in an assembled state, having a shaping member that is a string or wire.

FIG. 7 is a perspective view that illustrate assembly of multiple hose-shaping apparatuses on a single length of hose.

FIG. 8 is a perspective view of a hose-shaping assembly, in an assembled state, having a plurality of ribs without a spine portion.

FIG. 9 is a flowchart illustrating the steps of a method for shaping a length of hose using a hose-shaping apparatus disclosed herein.

FIG. 10 is a perspective view of a hose-shaping kit that includes a hose-shaping apparatus as disclosed herein.

### DESCRIPTION

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

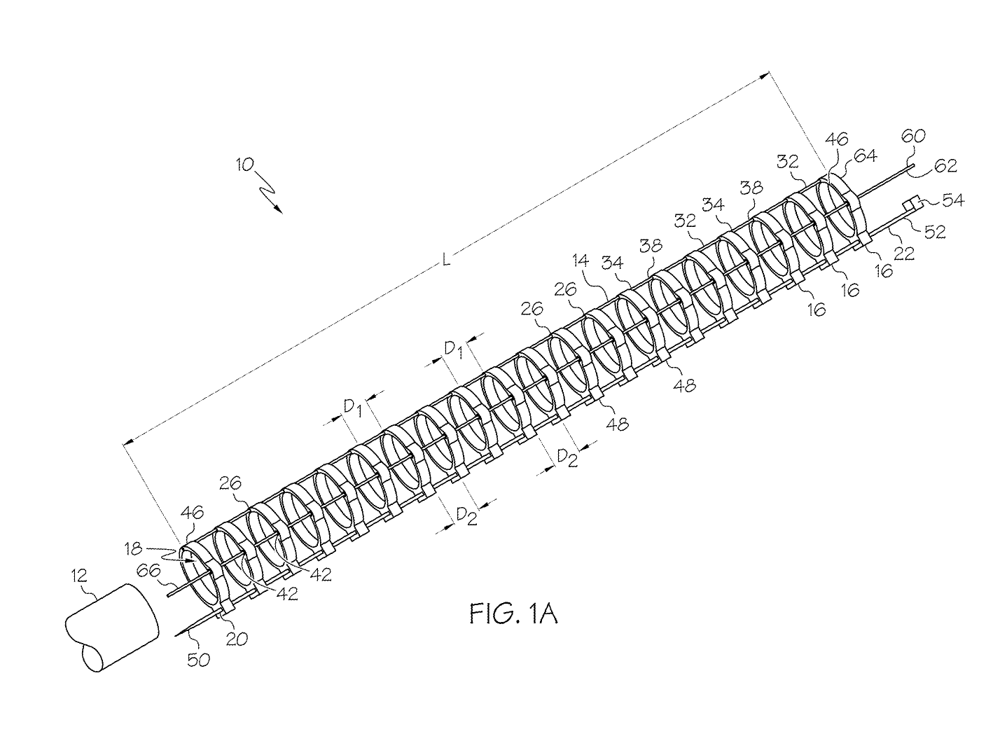

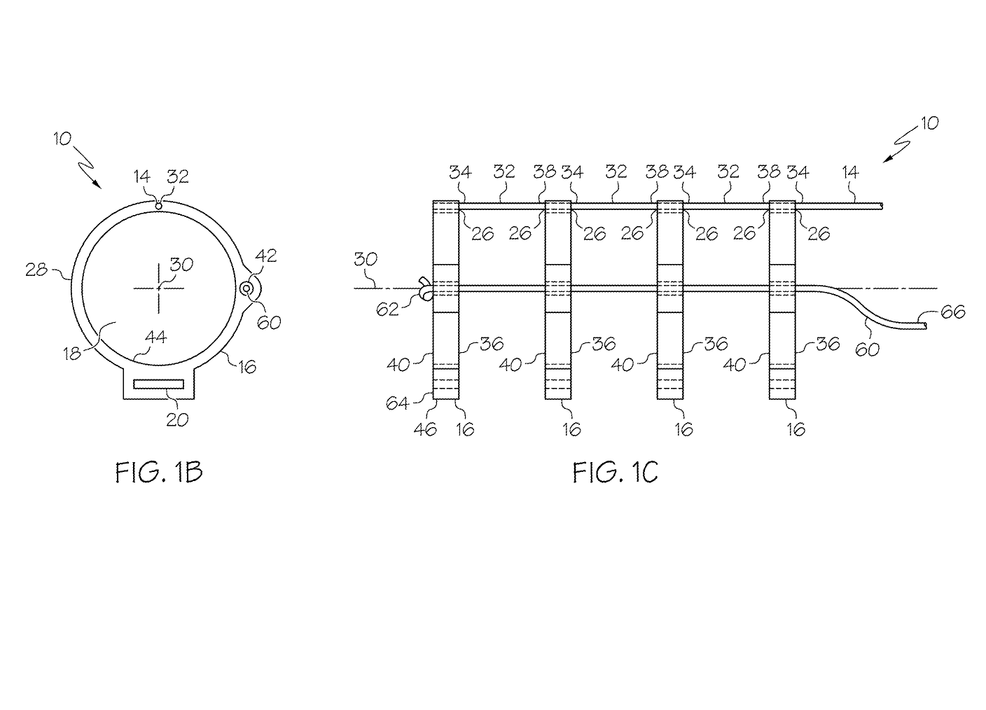

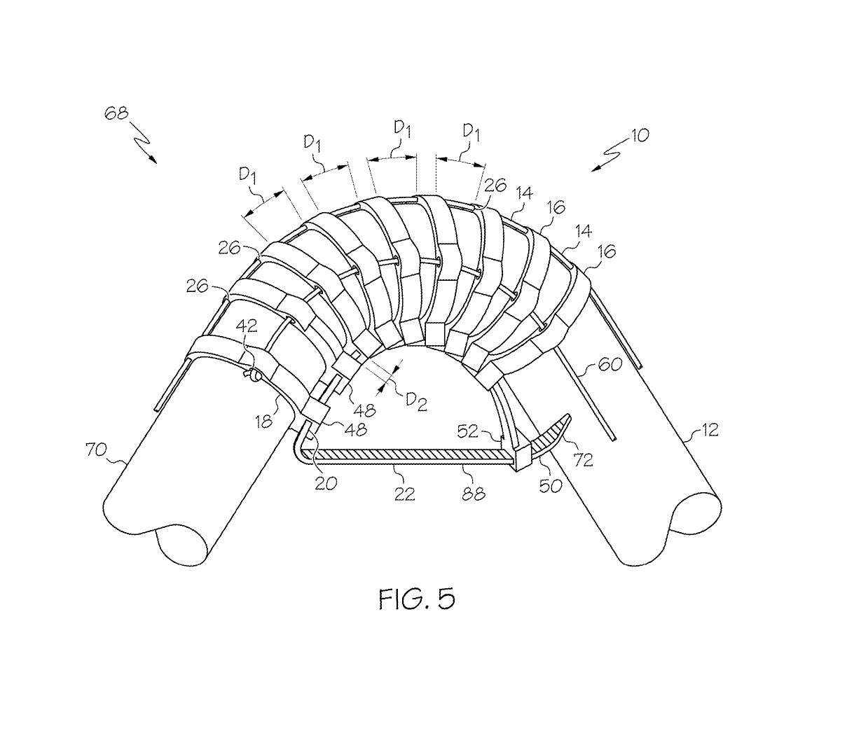

Referring to FIG. 1A, a hose-shaping apparatus 10 for bending a hose 12 into a custom shape is shown having a flexible spine 14 and a plurality of ribs 16 spaced apart from each neighboring rib along the spine 14. Each of the ribs 16 define a first opening 18 configured to receive a length of hose 12, and two or more of the ribs 16 define a second opening 20 configured to receive a shaping member 22 that, when inserted through the second openings 20 and tightened to achieve an assembled state, cause the hose 12, which has been inserted through the first openings 18, to form a bend, as illustrated in FIG. 5.

The spine 14 is flexible such that, when the shaping member 22 is tightened to form a bend in the hose 12, the spine 14 conforms to the bent shape of the hose 12. The spine 14 can be made of any convenient material having the flexibility to conform to a bend in the hose 12. Convenient materials for the spine 14 may include, but are not limited to, metals, plastics, rubber, fiberglass, other materials or combinations thereof. In one embodiment, the spine 14 is made of plastic. In another embodiment, the spine 14 is made of thin metal wire that bends to conform to the shape of the hose 12 when the hose-shaping apparatus 10 is assembled.

Referring to FIGS. 1A-1C, the spine 14 may be generally elongate to accommodate a plurality of ribs 16 coupled thereto and may have any convenient cross-sectional shape, which may include, but is not limited to, square, circular, rectangular, elliptical, or other convenient shape. The spine 14 may be severable, by cutting or snapping for example, at one or more locations along a length L of the spine 14 between two adjacent neighboring ribs 16 to enable the hose-shaping apparatus 10 to be divided into various smaller lengths to tailor the hose-shaping apparatus 10 to specific applications. With the hose-shaping apparatus 10 in an unassembled state, the spine 14 is generally parallel to a central axis 30 of the ribs 16. The spine 14 may be a plurality of spacers 32 coupled between the ribs 16. For each spacer 32, a first end 34 of the spacer 32 may be coupled to a first side 36 of a rib 16 and a second end 38 of the spacer 32 may be coupled to a second side 40 of an adjacent rib 16. In this arrangement, each of the ribs 16 has a coupling portion 26 on both the first side 36 and the second side 40 of the rib 16, and the two coupling portions 26 may be aligned axially such that the spacers 32 are aligned along a length L of the hose-shaping apparatus 10. In embodiments where the hose-shaping apparatus 10 is formed by molding, casting, or injection molding, the spine 14 may be integral with each rib 16 such that the coupling of the spacers 32 to the ribs 16 is continuous.

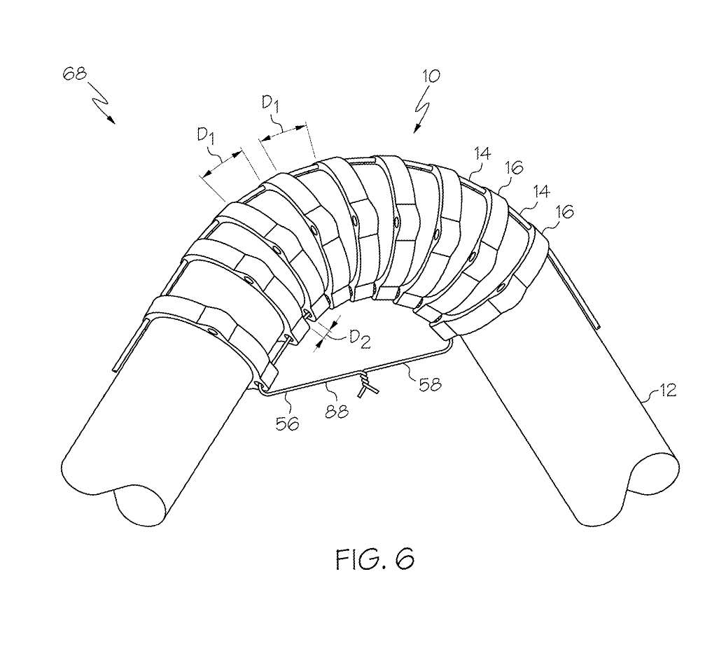

Each of the ribs 16 may be spaced apart from each of the other ribs 16 along a length L of the spine 14. In one embodiment, each of the ribs 16 is spaced apart from each of the other ribs 16 (neighboring ribs) at regular intervals along the length L of the spine 14 such that a distance between any two adjacent neighboring ribs 16 is generally constant. In one embodiment, the ribs 16 are spaced apart from each other at irregular intervals such that the distance between each of the ribs 16 varies along the spine 14. The spacing of the ribs 16 along the length L of the spine 14 may be determined by the type and/or size of the hose 12. For a larger diameter hose 12, the hose-shaping apparatus 10 may have fewer ribs 16 spaced farther apart (fewer ribs 16 per unit length of the spine 14), which may reduce the material costs of the hose-shaping apparatus 10. Likewise, a smaller diameter hose 12 may require more ribs 16 per unit length to adequately constrain the hose 12 within the hose-shaping apparatus 10 to maintain the intended shape of the hose 12. In an unassembled state, the spine 14 defines a pre-selected distance Dl, which may be fixed, between each of the plurality of ribs 16. The pre-selected distance D1 between each of the plurality of ribs 16 may be a maximum distance between each of the ribs 16. As the shaping member 22 is tightened during assembly into an assembled state, the distance Dl between the ribs 16 at the coupling portion 26 (near the spine 14) of the ribs 16 remains generally constant while a distance D2 between other portions 48 of the ribs 16 becomes less than the pre-selected distance D1, thereby forming the hose-shaping apparatus 10 into a curve or bend (see FIGS. 5-6). In other words, in an assembled state, the plurality of ribs 16, at a portion 48 generally opposite the spine 14, are spaced a distance D2, which is less than the pre-selected distance D1.

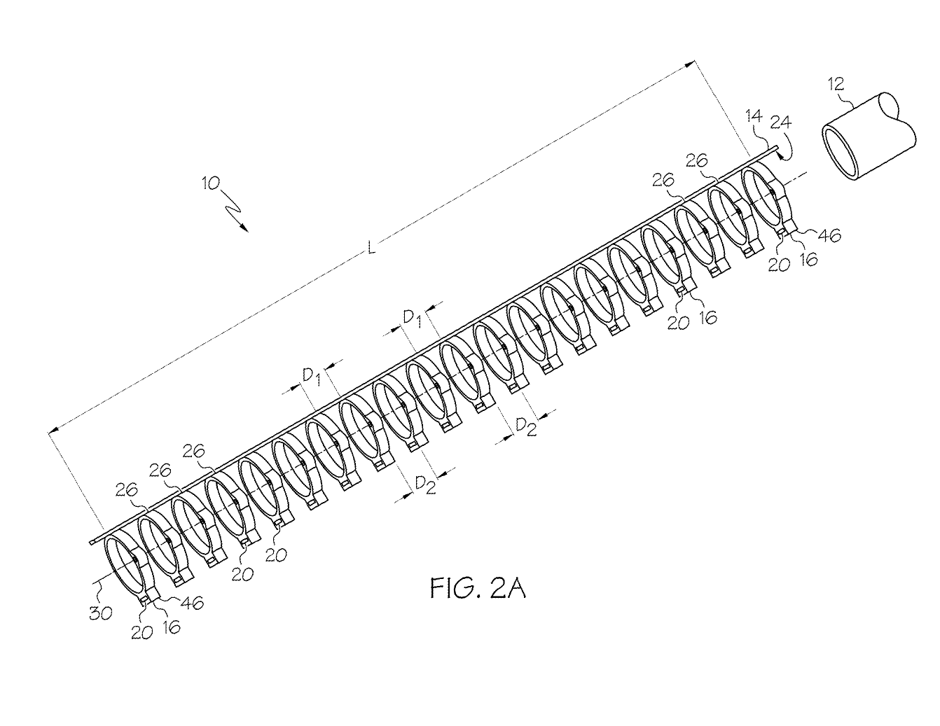

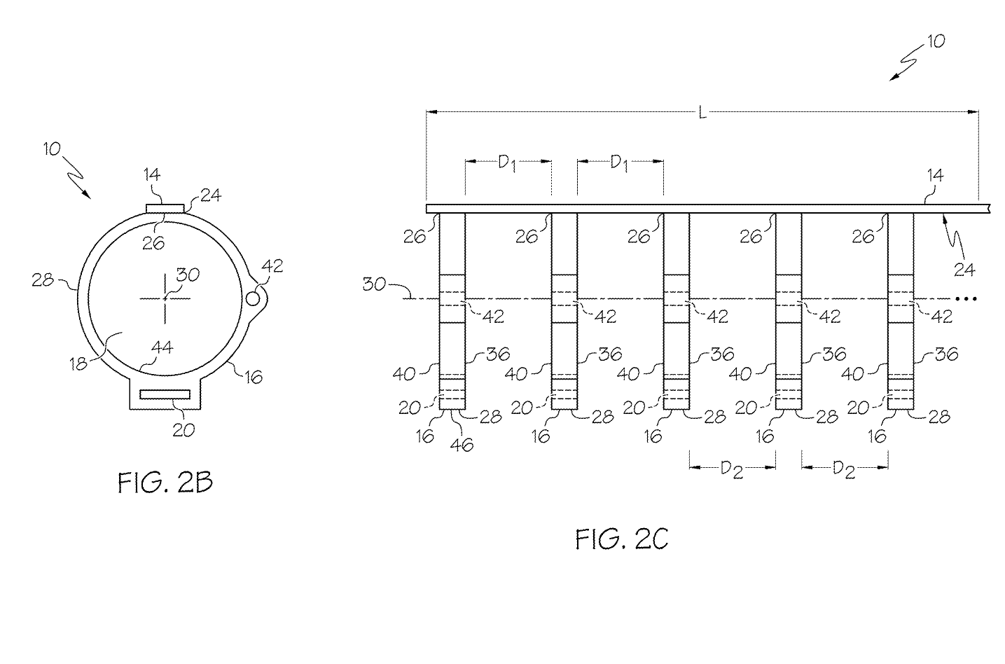

Referring now to FIGS. 2A-2C, the spine 14 may be a continuous strip of material rather than a series of spacers 32 disposed between each of the ribs 16. The spine 14 may have a coupling side 24, to which a coupling portion 26 of an outer periphery 28 of each of the ribs 16 is coupled. The plurality of ribs 16 may be coupled to the spine 14 at intervals along the length L of the spine 14. The ribs 16 may be coupled to the spine 14 by welding, brazing, adhering, pressing fitting, crimping, fastening, clipping, or other coupling means.

As shown in FIGS. 1A-1C and 2A-2C, each of the ribs 16 has a first opening 18, a second opening 20, a coupling portion 26, and optionally one or more third openings 42 (shown in FIG. 2B). The first opening 18 is generally defined in the center of the rib 16, extending through the rib axially with respect to the central axis 30 of the rib 16. The first opening 18 may be centered generally on the center axis 30 of the rib 16. A shape of the first opening 18 may be selected based on the shape of the hose 12 (FIG. 2A) with which the hose-shaping apparatus 10 is intended to be used. The shape of the first opening 18 may have any convenient cross-sectional shape, which may include, but is not limited to, circular, polygonal, square, elliptical, rectangular, triangular or other cross-sectional shape. In one embodiment, the rib 16 is generally cylindrically-shaped (annular) and defines a first opening 18 that is generally circular to receive a circular cylindrical hose 12 therethrough. The size of the first opening 18 is determined by the size of the hose 12 with which the hose-shaping apparatus 10 is intended to be used. In one embodiment, the first opening 18 may be sized to accommodate a range of types and sizes of hose 12. Each of the ribs 16 has an inner periphery 44 that defines the first opening 18 and faces generally inward toward the central axis 30 of the rib 16 and an outer periphery 28 that generally faces outward from the central axis 30 of the rib 16. Each of the ribs 16 also has a first side 36 and a second side 40 that face in opposing directions, which are axial relative to the central axis 30 of the ribs 16.

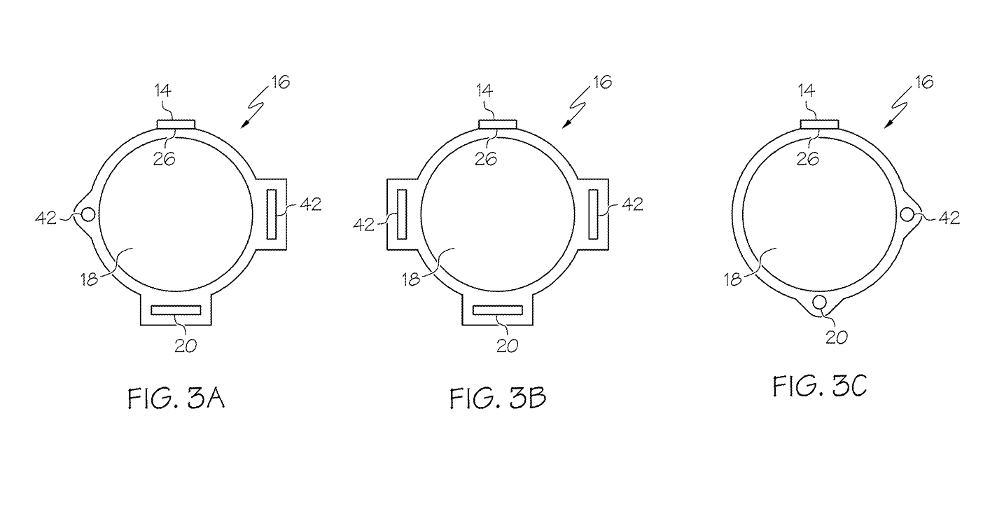

Two or more of the ribs 16 have a second opening 20 shaped to receive a shaping member therethrough. The second opening 20 is positioned away from the coupling portion(s) 26, which is where the rib 16 is coupled to the spine 14 (which can be a single elongate member as in FIGS. 2A-2C or a plurality of spacers as shown in FIGS. 1A-1C). In one embodiment, the second opening 20 is positioned on a portion of the rib 16 directly opposite from the coupling portion 26 (generally 180° from the coupling portion 26/spine 14). In other embodiments, the second opening 20 is positioned less than 180° from the coupling portion 26. Generally, the second opening 20 extends axially through the rib 16 at a position between the inner periphery 44 and the outer periphery 28. The second opening 20 has a convenient cross-sectional shape for receiving a shaping member 22 (FIGS. 1B and 2B). Convenient cross-sectional shapes for the second opening 20 may include, but are not limited to, circular, polygonal, rectangular, square, elliptical, triangular, or other convenient shape. In one embodiment, the second opening 20 is rectangular (as shown in FIG. 1B) and is sized to receive a shaping member 22 (FIG. 1A) that is a cable tie. In another embodiment, the second opening 20 is circular (as shown in FIG. 3C) and is sized to receive a shaping member 22 (see FIG. 6) that is a wire tie, wire, or string.

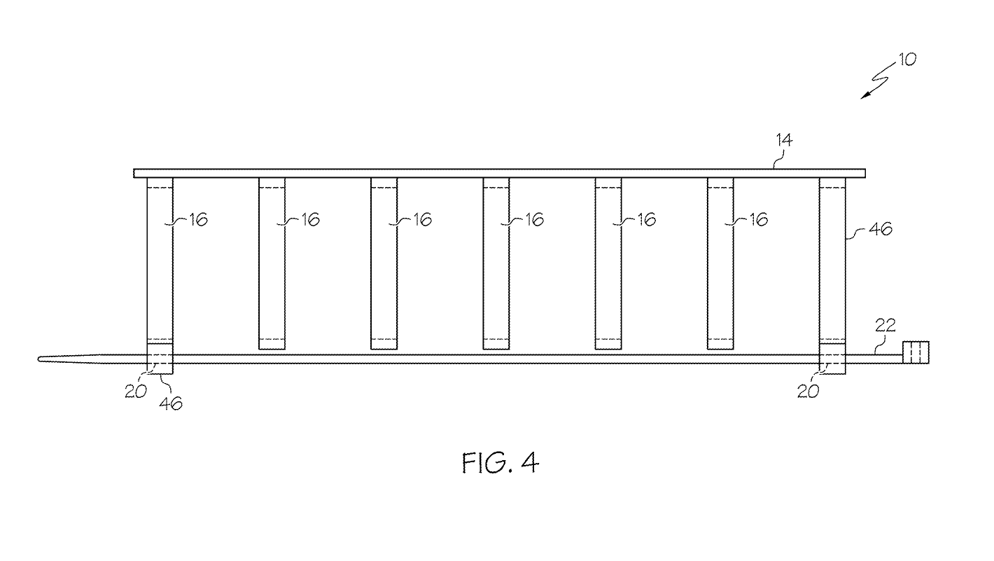

Referring back to FIGS. 1A-1C, all of the ribs 16 may have a second opening 20. Alternatively, a number of ribs 16 less than a total number of ribs 16 may have a second opening 20 such that less than all of the ribs 16 are engaged with the shaping member 22 when the hose-shaping apparatus 10 is assembled (see FIG. 4). These ribs 16 having a second opening 20 may be evenly spaced along the length L of the spine 14. In one embodiment, all of the ribs 16 have second openings 20 such that the shaping member 22 may pass through the second openings 20 in all of the ribs 16, thereby engaging all of the ribs 16 in forming the bend in the hose 12 (see FIG. 1A). Referring to FIG. 5, the hose-shaping apparatus 10 may have two terminal ribs 46 positioned at either end of the hose-shaping apparatus 10. These terminal ribs 46 may have second openings 20 while the rest of the plurality of ribs 16 do not have second openings 20 so that using the hose-shaping apparatus 10 requires passage of the shaping member 22 through only the two terminal ribs 46 and tightening the shaping member 22.

Referring to FIG. 1, the shaping member 22 is an elongate member capable of being inserted through the second openings 20 in the ribs 16 and tightened to form the hose-shaping apparatus 10 into a bend. The shaping member 22 may have an engaging end 50 and a receiving end 52. The engaging end 50 engages with the receiving end 52, and the receiving end 52 may have a locking mechanism 54 to prevent the engaging end 50 from disengaging from the receiving end 52. Alternatively as shown in FIG. 6, the shaping member 22 may have a first end 56 and a second end 58 that can be tied or secured together or secured to the hose-shaping apparatus 10 to tighten the hose-shaping apparatus 10 into an assembled state or shape. The ends (e.g., engaging end 50 and receiving end 52, or first end 56 and second end 58) of the shaping member 22 are mateable together—such as by engaging through a locking mechanism, tying, twisting, welding, coupling or otherwise securing—to form a loop (e.g., loop 88 in FIGS. 5, 6, and 8). The shaping member 22 may be, but is not limited to, a wire tie (wire), cable tie, string, strap, chain, rope, or other shaping member. The shaping member 22 may be constructed of any convenient partially bendable material, including, but not limited to, metal, plastic, nylon, synthetic fiber, natural fiber, natural or synthetic rubber, or other bendable material. In one embodiment, the shaping member 22 is a commercially available cable tie as illustrated in FIG. 1. In another embodiment, the shaping member 22 is a wire tie or wire that may be twisted around itself, as illustrated in FIG. 6, or around a rib 16 to secure the ends of the wire and hold the hose-shaping apparatus 10 in the assembled state.

As shown in FIGS. 1B, 2B, and 3A-3C, one or more of the ribs 16 may have one or more third openings 42 positioned between the spine 14 and the second opening 20. The third openings 42 may have any convenient shape, which may include, but is not limited to, circular, polygonal, rectangular, square, elliptical, triangular, or other convenient shape. The third openings 42 may receive a leader line 60 therethrough, as shown in FIGS. 1A-1C, to facilitate pulling the hose-shaping apparatus 10 onto the hose 12 to be shaped. A first end 62 of the leader line 60 may be secured to an initial rib 64, such as by tying, for example, and a second end 66 of the leader line 60 is then threaded through the third openings 42 in one or more other ribs 16, which may be immediately adjacent to the initial rib 64 or spaced apart from the initial rib 64. The second end 66 of the leader line 60 may be a free end to which the user of the hose-shaping apparatus 10 grasps to pull the hose-shaping apparatus 10 onto the hose 12. The leader line 60 may be a string, wire, filament, or other line capable of being secured to an initial rib 64 and received through the third openings 42. The third openings 42 may also be shaped to receive a secondary shaping member (not shown) so that a single length of the hose-shaping apparatus 10 may be used to shape the hose 12 with respect to two different planes in the same bend using the same length of hose-shaping apparatus 10.

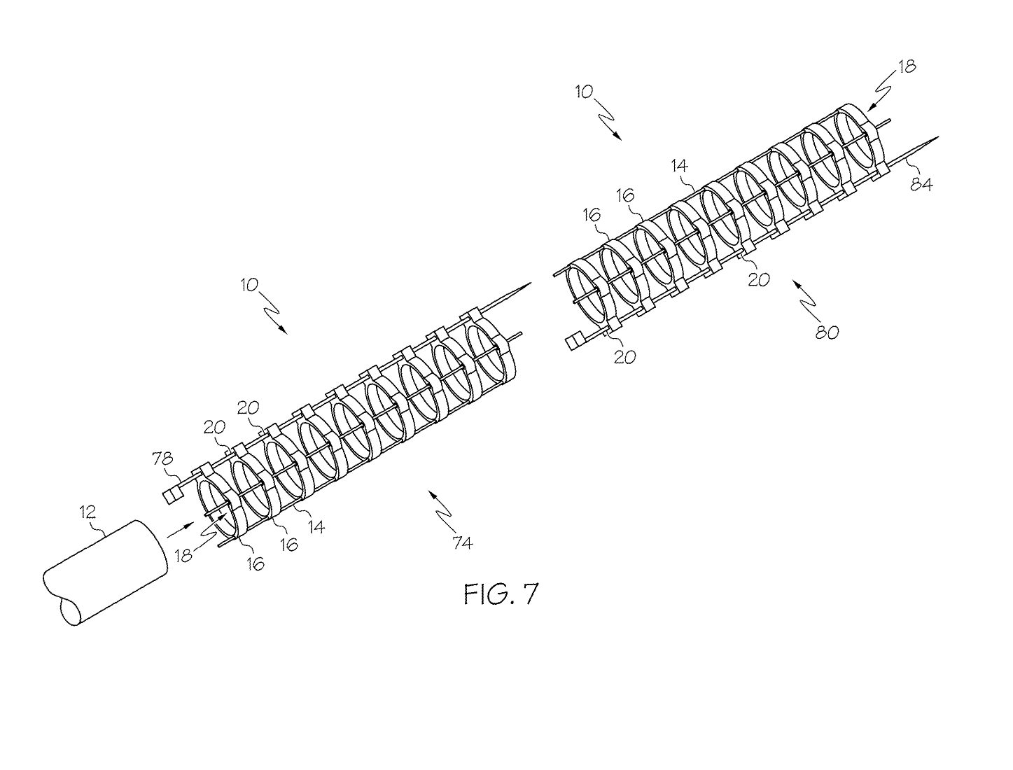

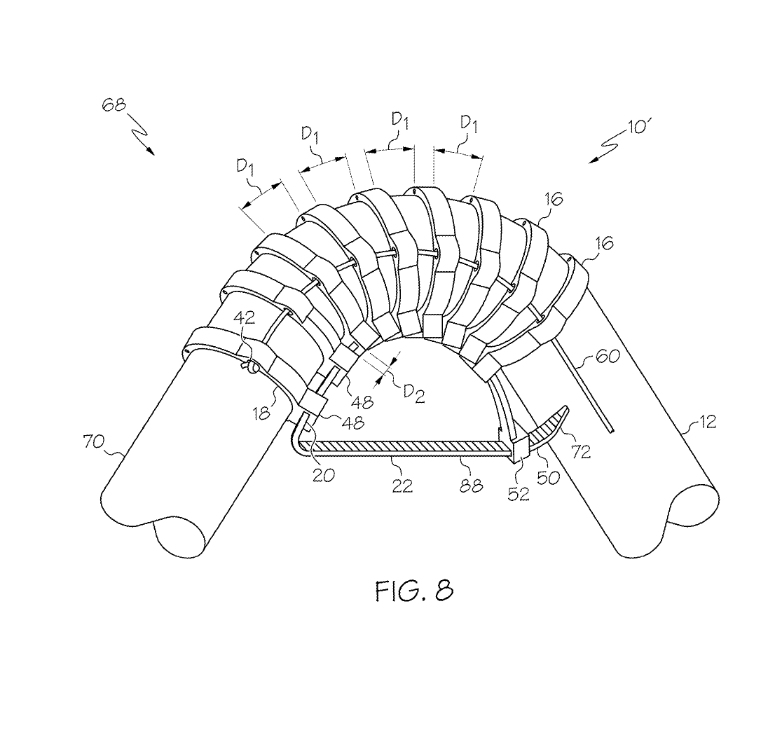

Referring now to FIG. 5, a hose assembly 68 is shown that includes a hose 12 and a hose-shaping apparatus 10 as disclosed herein. The hose 12 is inserted through the first openings 18 of the ribs 16 of the hose-shaping apparatus 10, and a shaping member 22 is disposed through the second openings 20 of the ribs 16. The ends 50, 52 of the shaping member 22 are mated (e.g., engaged, coupled, otherwise secured) together to form a loop 88. The shaping member 22 is tightened to reduce a size of the loop 88 and secured to bend the hose-shaping apparatus 10, and thus the hose 12 disposed therethrough, into an assembled state in which the distance D₁ between ribs 16 near the spine 14 is maintained generally at the pre-selected distance by the spine 14, and the distance D₂ between ribs 16 at portions of the ribs 16 opposite the spine 14 is decreased. The hose assembly 68 may also have a leader line 60 disposed through the third openings 42 in the ribs 16. The hose assembly 68 may include a hose 12 and two or more hose-shaping apparatuses 10 disposed thereon to shape the hose 12 into two or more different bends, each bend separated from an adjacent bend by a generally straight portion 86 of the hose 12 (see FIG. 7). The hose-shaping apparatuses 10 may shape the hose 12 into bends in the same bend plane, or each hose-shaping apparatus 10 may bend the hose 12 in a bend plane different than the other hose-shaping apparatuses 10.

The hose-shaping apparatuses 10 disclosed herein are used to shape a straight length of hose 12 into one or more bends. To form the one or more bends, the hose-shaping apparatus 10 may be trimmed to a length sufficient to achieve the intended shape of the hose 12 having a shape length and a curvature. The trimming is achieved by cutting the spine 14 at a position between two adjacent neighboring ribs 16. The hose 12 may be inserted into the hose-shaping apparatus 10 by feeding the hose 12 through the first openings 18 of the plurality of ribs 16. In one embodiment, the ribs 16 have third openings 42 that receive a leader line 60, which may be used to pull the hose-shaping apparatus 10 over the length of hose 12 to be shaped. The hose-shaping apparatus 10 is positioned axially along the length of the hose 12. The hose-shaping apparatus 10 may also be rotationally positioned by rotating the hose-shaping apparatus 10 around the exterior 70 of the hose 12. The hose-shaping apparatus 10 is axially and rotationally positioned on the hose 12 such that assembly of the hose-shaping apparatus 10, by inserting and tightening the shaping member 22, will result in the shape intended by the user. The shaping member 22 is inserted through the second openings 20 of two or more ribs. The shaping member 22 may be inserted through the second openings 20 before or after the hose 12 is inserted through the first openings 18 and before or after positioning the hose-shaping apparatus 10 on the hose 12. The ends 50, 52 (or 56 and 58 in FIG. 6) of the shaping member 22 are mated together to form a loop 88. The shaping member 22 is tightened as shown in any one of FIGS. 5, 6, and 8, which refers to reducing the length of the shaping member 22 that is disposed through the second openings in the ribs 16, thus reducing a size of the loop 88, to draw the ribs 16 closer together. Tightening the shaping member 22 causes portions 48 of ribs 16 in the vicinity of the second openings 20 to move closer together such that the distance D₂ between those portions 48 of the ribs 16 in the vicinity of the second openings 20 is less than the pre-selected distance D₁ at the spine 14, thereby causing the hose 12 disposed through the first openings 18 in the plurality of ribs 16 to curve into a bent shape. The distance D₁ between the ribs 16 at the coupling portions 26, where the ribs 16 are coupled to the spine 14, may decrease slightly as the spine 14 bends in response to tightening the shaping member 22 but remains greater than the distance D₂ between the ribs 16 at the portions 48 near the second opening 20.

After tightening, the shaping member 22 may be secured to maintain the hose 12 in the bent shape. Once the shaping member 22 is secured, an excess portion 72 of the shaping member 22 may be trimmed or cut off. In one embodiment, the shaping member 22 is a cable that is secured by inserting the engaging end 50 into the receiving end 52 and pulling the engaging end 50 through the receiving end 52, which has a locking mechanism 54 to prevent the engaging end 50 from disengaging from the receiving end 52 (see FIG. 5). In another embodiment, the shaping member 22 is a string that may be secured by tying the string to each of the ribs 16 of the hose-shaping apparatus 10 (see FIG. 6). In another embodiment, the shaping member 22 may be a wire or wire tie that may be tied or twisted around the rib 16 or the hose-shaping apparatus 10 to secure the hose-shaping apparatus 10 in the intended bend or shape.

Referring now to FIG. 7, two or more sections of the hose-shaping apparatus 10 may be used to create two or more bends in a single length of hose 12 by assembling the two or more sections of hose-shaping apparatus 10 in series. The hose 12 is inserted through the first openings 18 in the ribs 16 of a first section 74 of the hose-shaping apparatus 10, and the first section 74 of hose-shaping apparatus 10 is positioned axially and rotationally to achieve a first bend 76 or shape in the hose 12. A first shaping member 78 is inserted through the second openings 20 in the first section 74 of the hose bending apparatus 10 and tightened to shape the hose 12 into the first bend 76. The first shaping member 78 is secured to maintain the hose 12 in the shape of the first bend 76. The unshaped portion 79 of the hose 12 is inserted through the first openings 18 in the ribs 16 of a second section 80 of the hose-shaping apparatus 10 and is positioned axially and rotationally to achieve a second bend 82 or shape in the hose 12. In some embodiments, the first section 74 and the second section 80 of the hose-shaping apparatus 10 may be positioned on the hose 12 before either the first section 74 or second section 80 are tightened into a bend. A second shaping member 84 is inserted through the second openings 20 in the ribs 16 of the second section 80 of the hose-shaping apparatus 10 and tightened to bend the hose 12 into a second bend 82. The second shaping member 84 is secured to maintain the shape of the hose 12 in the second bend 82. The resulting hose 12 is shaped into a first bend 76 and a second bend 82 separated by a straight portion 86 of hose 12 extending therebetween. The first shaping member 78 and second shaping member 84 may be inserted through the second openings 20 in the ribs 16 before the first section 74 and the second section 80 of hose-bending apparatus 10 are slid or pulled onto the hose 12. Subsequent sections (not shown) of the hose-shaping apparatus 10 may be used to shape the hose 12 into additional bends.

In one embodiment, the first section 74 of the hose-shaping apparatus 10 and the second section 80 of the hose-shaping apparatus 10 are positioned axially and rotationally so that the hose 12 is bent in two different directions within the same plane (see FIG. 7C). In another embodiment, the first section 74 of the hose-shaping apparatus 10 shapes the hose 12 into a first bend 76 in a first bend plane, and the second section 80 of the hose-shaping apparatus 10 shapes the hose 12 into a second bend 82 in a second bend plane, which differs from the first bend plane (not shown). In one embodiment, a single hose-shaping apparatus 10 is cut into a plurality of sections for shaping a length of hose into a plurality of bends or shapes (not shown).

Though shown in previous embodiments as coupled to a spine, the ribs 16 may be also be provided as individual separate pieces, which may then be linked or integrated together into a hose-shaping system 10′ in a manner determined by a user. As shown in FIG. 8, a user may thread the hose 12 through the first opening 18 in each of the ribs 16 individually. A user could also use a leader line 60 or a shaping member 22 to pull all of the ribs 16 onto the hose 12 at once. The shaping member 22 may be inserted through the second openings 20 in the ribs 16. The hose 12 may be manipulated into the intended shape, and the shaping member 22 tightened to maintain the hose 12 in the intended shape by mating the mateable ends 50, 52 of the shaping member 22 together to form a loop 88. Tightening the shaping member 22 draws portions of the ribs 16 having the second openings 20 closer together than other portions of the ribs 16, such that a second distance D2 between the ribs 16 at a portion of the ribs 16 closer to the second openings 20 is less than a first distance D1 between the ribs 16 at a portion of the ribs 16 opposite the second openings 20. In an assembled state, a distance between the ribs 16 increases moving from the second openings 20 to the portion of the ribs 16 opposite the second openings 20.

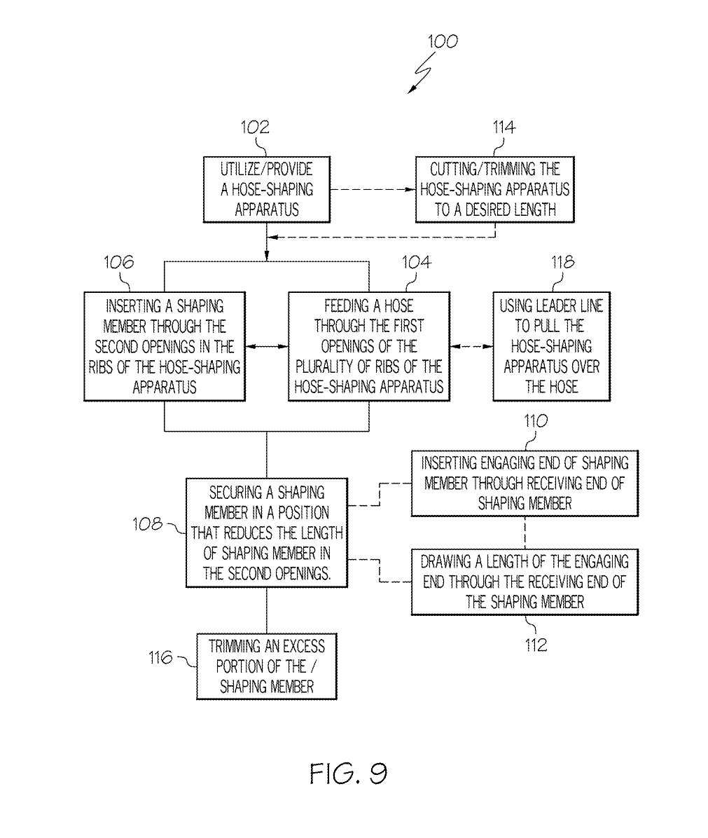

Referring to FIG. 9, a method 100 of shaping a length of hose using the hose-shaping apparatus includes the steps of utilizing or providing 102 a hose-shaping apparatus as disclosed herein; feeding 104 a hose through the first openings of the plurality of ribs in the hose-shaping apparatus; inserting 106 a shaping member through the second openings of the plurality of ribs; and securing 108 the shaping member in a position that reduces the length of the shaping member within the second openings, thereby drawing the portion of the plurality of ribs having the second openings closer to one another to form at least a first bend in the hose. Inserting 106 the shaping member through the second openings of the plurality of ribs may be performed before or after the step of feeding 104 the hose through the first openings of the plurality of ribs in the hose-shaping apparatus. The securing 108 the shaping member step may include inserting 110 an engaging end of the shaping member into a receiving end of the shaping member and drawing 112 a length of the shaping member through the receiving end. The method 100 may additionally include the step of cutting or trimming 114 the hose-separating apparatus to a desired length by cutting the spine between adjacent neighboring ribs. The method may further include trimming 116 an excess portion of the length of the shaping member after securing the shaping member. The method may further include providing 102 a hose-shaping apparatus that has a leader line disposed through third openings in the ribs and using 118 the leader line to pull the hose-shaping apparatus onto the hose.

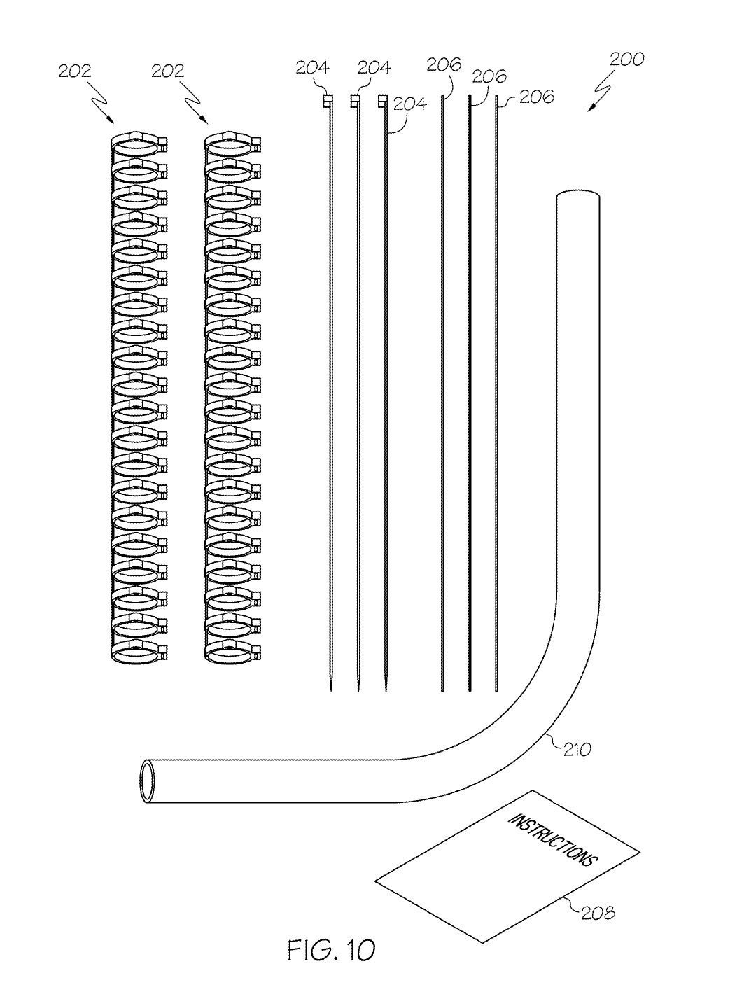

As shown in FIG. 10, a hose-shaping kit 200 may include one or more lengths of the hose-shaping apparatus 202 having a plurality of ribs spaced apart from each neighboring rib along a flexible spine, as disclosed herein, and one or more shaping members 204. The hose-shaping kit 200 may also have a plurality of individual ribs (not shown in FIG. 10) in addition to or in place of the one or more lengths of the hose-shaping apparatus 202. The hose-shaping kit 200 may optionally include one or more leader lines 206 and may include instructions for use 208. The one or more shaping members 204 may be all the same size and shape of shaping member 204, or the hose-shaping kit 200 may include a variety of types and sizes of shaping members 204. The hose-shaping kit 200 may include a plurality of hose-shaping apparatuses 202 of varying sizes (size referring to one of the cross-sectional diameter of the first openings in the ribs, length of hose-shaping apparatus, or distance between ribs along the length of the spine) to accommodate different types and sizes of hoses/hose segment 210. The hose-shaping kit 200 may have a single long length of hose-shaping apparatus 202 that may be cut into multiple smaller lengths of the hose-shaping apparatus (not shown). Optionally, the hose-shaping kit 200 may also include one or more hose segments 210. The hose segments 210 may be a specific type and length for a particular application. The kit 200 may include hose segments 210 and hose-shaping apparatuses 202 that are pre-cut for specific vehicle engines or specific vehicle engine subsystems. In one embodiment, a hose-shaping kit 200 includes hoses 210 and hose-shaping apparatuses 202 having sizes and lengths specific to a particular vehicle engine. In another embodiment, a hose-shaping kit 200 includes hoses 210 and hose-shaping apparatuses 202 having sizes and lengths specific to a specific subsystem of a vehicle engine. In another embodiment, a hose-shaping kit 200 may include a variety of hoses 210 and hose-shaping apparatuses 202 of selected sizes and lengths to accommodate a range of vehicle engine subsystems.

The hose-shaping apparatus disclosed herein may enable a vehicle owner to inexpensively create custom-shaped hoses having multiple bends in multiple bend planes to better approximate the custom-shaped hoses installed in the vehicle engine by the OEM. The hose-shaping apparatus may enable duplication any hose configuration without having to stock a large quantity of pre-formed hoses for all of the various possible applications. Having an inexpensive method to form hoses into custom shapes for the aftermarket may reduce the desirability to vehicle owners of blocking off certain fluid communication conduits within the vehicle engine or installing inappropriate and poorly fitting substitutes. The hose-shaping apparatus may enable a vehicle owner to achieve a tighter bend in the hose. The hose-shaping apparatus may have a lower cost than other solutions and may be easier to use. The hose-shaping apparatus may also be adaptable to a number of bends from one kit by being trimmed to various lengths. Having a device to enable a vehicle owner to create custom-shaped hoses may enable the vehicle owner to retain more stock appearance of the vehicle engine.

Although the invention is shown and described with respect to certain embodiments, it is obvious that modifications will occur to those skilled in the art upon reading and understanding the specification, and the present invention includes all such modifications.

What is claimed is:

1. A hose-shaping apparatus comprising:
a plurality of ribs each spaced apart from each neighboring rib along a flexible spine, each rib defining a first opening for receiving a section of hose and two or more ribs further defining a second opening for receiving a shaping member that secures the plurality of ribs in an assembled state to affect a bend in the section of hose;
wherein the flexible spine, in an unassembled state, defines a preselected distance between the plurality of ribs, and in the assembled state, the plurality of ribs, at a position generally opposite the spine, are spaced apart a distance less than the preselected distance.

2. The hose-shaping apparatus of claim 1, wherein each of the plurality of ribs is generally cylindrically-shaped.

3. The hose-shaping apparatus of claim 1, wherein the second opening is shaped to receive a wire, cable tie, string, or strap for securing the hose-shaping apparatus in an assembly position about a hose.

4. The hose-shaping apparatus of claim 1, wherein the second opening is positioned generally opposite the spine.

5. The hose-shaping apparatus of claim 1, wherein one or more of the plurality of ribs further defines a third opening for receiving a leader line to pull the hose-shaping apparatus onto a hose or for receiving a secondary shaping member.

6. The hose-shaping apparatus of claim 1, further comprising a shaping member received through the second openings.

7. The hose-shaping apparatus of claim 6, wherein the shaping member has an engaging end that is engageable with a receiving end, and wherein the receiving end has a locking mechanism to prevent disengagement of the engaging end from the receiving end.

8. The hose-shaping apparatus of claim 6, wherein the shaping member comprises one or more cable ties.

9. A hose assembly comprising:
a hose-shaping apparatus according to claim 1;
a hose received through the first opening of each of the plurality of ribs of the hose-shaping apparatus; and
a shaping member received through the second openings of the plurality of ribs that have a second opening;
wherein the shaping member is tightened to manipulate the hose-shaping apparatus and the hose into at least a first bend.

10. The hose assembly of claim 9, wherein the shaping member is a wire tie having a locking mechanism to prevent disengagement of an engaging end of the wire tie from a receiving end of the wire tie.

11. The hose assembly of claim 9, wherein the shaping member is a cable tie.

12. A method for shaping a hose comprising:
utilizing a hose-shaping apparatus of claim 1;
feeding a hose through the first openings of the plurality of ribs;
inserting a shaping member through the second openings of the plurality of ribs; and
securing the shaping member in a position that reduces the length of the shaping member within the second openings, thereby drawing the portion of the plurality of ribs having the second openings closer to one another to form at least a first bend in the hose.

13. The method of claim 12, wherein securing the shaping member comprises inserting an engaging end of the shaping member into a receiving end thereof and drawing a length of the shaping member through the receiving end.

14. The method of claim 12, further comprising cutting the hose-shaping apparatus to a desired length by cutting the spine between adjacent neighboring ribs.

15. The method of claim 12, wherein one or more of the plurality of ribs has a third opening;
and the method further comprises:
securing a leader to the third openings in the plurality of ribs; and
feeding the hose further comprises pulling the hose-shaping apparatus onto the hose using the leader.

16. A hose-shaping kit comprising:
a plurality of individual ribs and/or a hose-shaping apparatus having a plurality of ribs spaced apart from each neighboring rib along a flexible spine, each rib defining a first opening to receive a length of a hose and two or more ribs further defining second openings; and
a shaping member to be inserted through the second openings and to be tightened to assemble the plurality of individual ribs and/or the hose-shaping apparatus into an assembled state in which the plurality of individual ribs and/or the plurality of ribs, at a position of the second opening, are to be spaced apart a distance less than other portions of the ribs.

17. The hose-shaping kit of claim 16, wherein each rib further defines a third opening, and wherein the hose-shaping kit further comprises:
a leader line to be coupled to an initial rib and inserted through the third openings of the other ones of the plurality of individual ribs and/or plurality of ribs; and
wherein the leader line is to be used to pull the plurality of individual ribs and/or plurality of ribs onto the section of hose.

18. The hose-shaping kit of claim 16, further comprising a plurality of hose-shaping apparatuses of at least two different sizes; wherein one or more of the plurality of hose-shaping apparatuses is to be selected for a specific size of hose.

19. A hose-shaping system comprising:
a plurality of ribs defining a first opening for receiving a section of hose and defining a second opening; and
a shaping member insertable through the second opening in the plurality of ribs and having ends that connect together to form a loop for defining a shape of the section of hose.

20. The hose-shaping system of claim 19, wherein tightening the shaping member reduces the size of the loop and causes a distance between each of the plurality of ribs to decrease with increasing proximity to the second opening.
